(19) United States
(12) Patent Application Publication
(10) Pub. No.: US 2022/0107829 A1
(43) Pub. Date: Apr. 7, 2022

(54) ENVIRONMENT AGNOSTIC REMOTE MANAGEMENT OF HETEROGENEOUS SERVERS AND VIRTUAL MACHINES

(71) Applicant: Dell Products L.P., Round Rock, TX (US)

(72) Inventors: Deepaganesh PAULRAJ, Bangalore (IN); Ankit SINGH, Bangalore (IN); Vinod P S, Bangalore (IN)

(73) Assignee: Dell Products L.P., Round Rock, TX (US)

(21) Appl. No.: 17/062,260

(22) Filed: Oct. 2, 2020

(51) Int. Cl. G06F 9/455

(52) U.S. Cl. CPC G06F 9/45558; G06F 2009/45579; G06F 2009/4557

(57) ABSTRACT

An information handling system may include a host system and a management controller configured to provide out-of-band management of the information handling system. The information handling system may be configured to receive power management instructions via a power input of the information handling system according to a power-line communication protocol. The management controller may be configured to execute the power management instructions, wherein executing the power management instructions includes performing at least one operation selected from the group consisting of: powering on the host system, powering off the host system, powering on a virtual machine, and powering off a virtual machine.

### TECHNICAL FIELD

The present disclosure relates in general to information handling systems, and more particularly to management of heterogeneous information handling systems including host systems and/or virtual machines (VMs).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As discussed in more detail below, some information handling systems may include both a host system and a management controller for performing management tasks such as out-of-band management of the host system. Existing solutions, however, may not be able to address adequately situations that can arise during unexpected power outages. For example, when power returns after an outage, it may be necessary to turn a system back on. If the IP address of the system on an out-of-band management network is unknown, it can become impossible to do so remotely.

Currently, if the management network (which may be dedicated or shared) is down or unreachable for any reason, out-of-band power management is not feasible. In a heterogeneous environment where different vendors of servers are present, and in which hypervisors executing VMs are present, this situation can be even more cumbersome due to differences in the available management tools for different types of system.

Accordingly, embodiments of this disclosure may provide improvements in this field.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with management of heterogeneous information handling systems and/or virtual machines may be reduced or eliminated.

In accordance with embodiments of the present disclosure, an information handling system may include a host system and a management controller configured to provide out-of-band management of the information handling system. The information handling system may be configured to receive power management instructions via a power input of the information handling system according to a power-line communication protocol. The management controller may be configured to execute the power management instructions, wherein executing the power management instructions includes performing at least one operation selected from the group consisting of: powering on the host system, powering off the host system, powering on a virtual machine, and powering off a virtual machine.

In accordance with these and other embodiments of the present disclosure, a method may include: in an information handling system comprising a host system and a management controller configured to provide out-of-band management of the information handling system: receiving power management instructions via a power input of the information handling system according to a power-line communication protocol; and the management controller executing the power management instructions, wherein executing the power management instructions includes performing at least one operation selected from the group consisting of: powering on the host system, powering off the host system, powering on a virtual machine, and powering off a virtual machine.

In accordance with these and other embodiments of the present disclosure, an apparatus may include a processor, a communications module configured to receive power management instructions from a user, and a power-line communication module for communicating with at least one information handling system via a power distribution line. The apparatus may be configured to transmit the power management instructions to the at least one information handling system via the power distribution line according to a power-line communication protocol. A management controller of the information handling system may be configured to execute the power management instructions, wherein executing the power management instructions includes performing at least one operation selected from the group consisting of: powering on a host system of the information handling system, powering off the host system, powering on a virtual machine, and powering off a virtual machine.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example datacenter, in accordance with embodiments of the present disclosure;

FIG. 3 illustrates a block diagram of an example PLC hub, in accordance with embodiments of the present disclosure;

FIG. 4 illustrates a block diagram of an example information handling system, in accordance with embodiments of the present disclosure; and

FIG. 5 illustrates an example unified power management protocol, in accordance with embodiments of the present disclosure.

### DETAILED DESCRIPTION

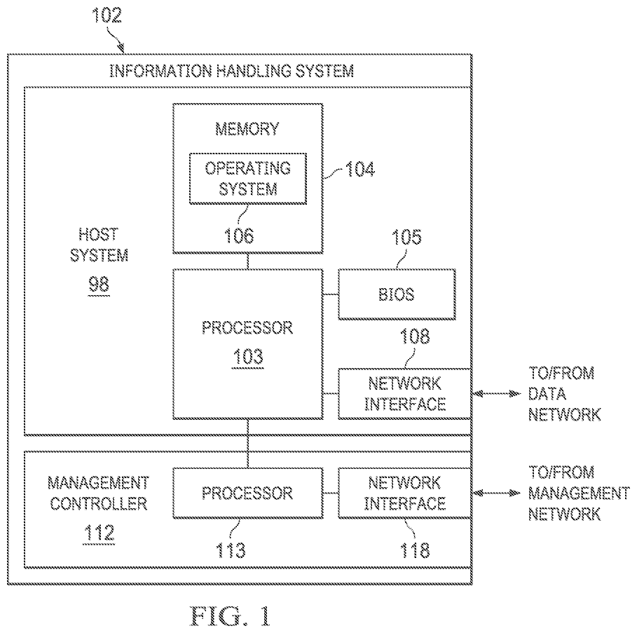

Preferred embodiments and their advantages are best understood by reference to FIGS. 1 through 5, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As noted above, if information handling system 102 is not reachable via the management network, then out-of-band power management of information handling system 102 using management controller 112 may not be not possible using existing techniques. Accordingly, a power-line communication (PLC) hub (not shown in FIG. 1) may also be coupled to information handling system 102 to enable additional communication channels.

For example, a PLC hub may include built-in GSM and/or broadband and/or other connectivity to allow users to connect to it (e.g., from outside the datacenter in which information handling system 102 resides). The PLC hub may be connected to a power distribution line of the datacenter using power-line networking technologies. Authorized users may remotely access the PLC hub over a mobile network or through any other desired network connection to manage systems in the datacenter via the power-line network connection by sending commands. Such commands may be sent via any desired protocol, including without limitation a Unified Power Management Protocol (UPMP) as discussed herein.

The PLC hub may also have a built-in Ethernet interface which may be connected to the data network discussed above. In particular, many of the uses for the PLC hub are most relevant when the management network is unavailable; accordingly, a connection to the data network is advantageous. Authorized users may also be able to reach the PLC hub over the data network and instruct it to perform management actions through UPMP or any other desired management protocol.

The PLC hub may send commands over the power distribution line to the destination system(s), where a decoding circuit (which may be located, for example, in a power supply unit (PSU) or on the motherboard) may be used to separate the control commands from the 50/60 Hz AC mains signal (or DC signal in systems that use DC power). The decoded control commands may then be sent to a management controller such as management controller 112, which in turn may execute the commands to perform the desired management tasks.

The commands available via UPMP or other desired management protocols may support various control operations, including but not limited to: host power ON/OF, VM power ON/OFF, power budget related operations, power consumption related operations, power capping related operations, system status monitoring, etc. In these and other embodiments, the protocols may also specify operations to be taken with respect to individual information handling resources (e.g., a GPU may be instructed to power off or go into a low power state, etc.). The details of some of power management features are described in U.S. Pat. No. 10,405,461, issued Sep. 3, 2019, which is incorporated by reference herein in its entirety. The power management commands according to this disclosure may implement any of such functionality, as well as additional functionality.

Such commands may be applied to heterogeneous information handling systems (e.g., systems from different manufacturers), as well as to VMs that may be executing on such systems. For example, VMs may be started, shut down, etc. based on the commands sent via the PLC hub.

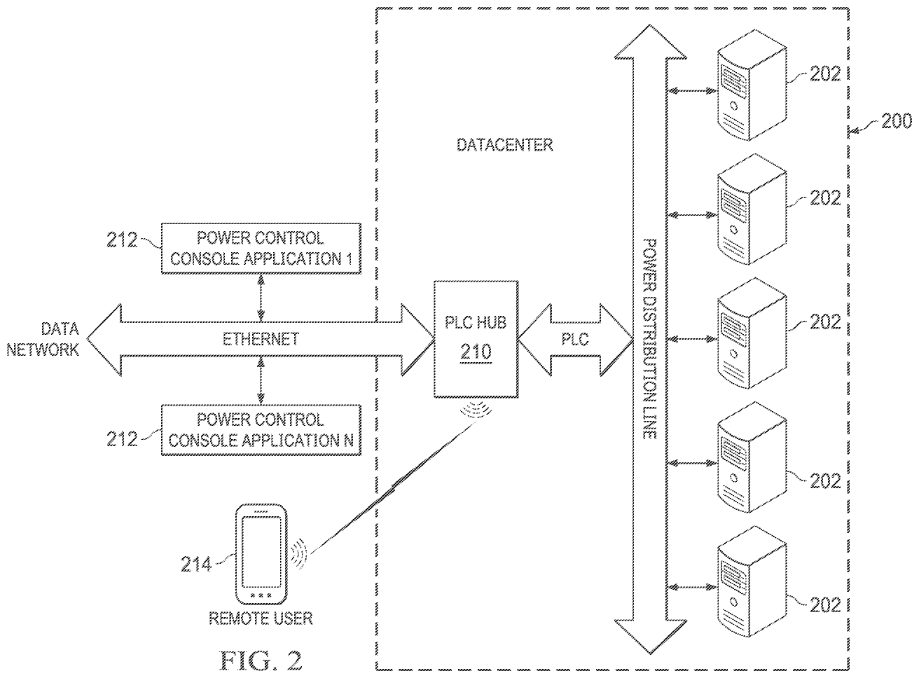

Turning now to FIG. 2, a block diagram is shown of an example datacenter 200 including a plurality of information handling systems 202 (which may be homogeneous or heterogeneous), in accordance with embodiments of the present disclosure.

As shown in FIG. 2, a user may connect to PLC hub 210 within datacenter 200 via a power control console application 212, which may be coupled to PLC hub 210 via a data network such as the Internet. The user may also connect to PLC hub 210 using a wireless connection (e.g., GSM, 3G, 4G, 5G, etc.) via a mobile device 214. PLC hub 210 may receive commands from the user and dispatch such commands to any desired information handling system 202 via the power distribution lines within the datacenter. PLC hub 210 may also return status information, error codes, and the like to the user in some embodiments.

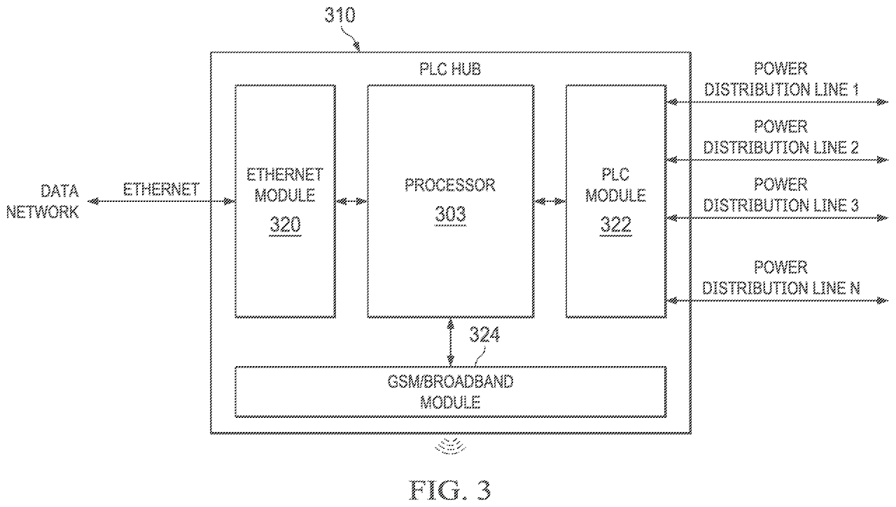

Turning now to FIG. 3, a block diagram of an example PLC hub 310 is shown, in accordance with some embodiments of the present disclosure. PLC hub 310 may include a processor 303, an Ethernet module 320 for communicating with the data network, a GSM/broadband module for communicating with wireless users, and a PLC module 322 for performing power-line communication with the various information handling systems within the datacenter. PLC module 322 may include one connection to the power distribution lines in the datacenter, in which case every information handling system may receive commands and then determine whether or not or the commands were intended for that system. In other embodiments, PLC module 322 may include a plurality of connections to the power distribution lines, in order to allow targeting commands to a particular information handling system.

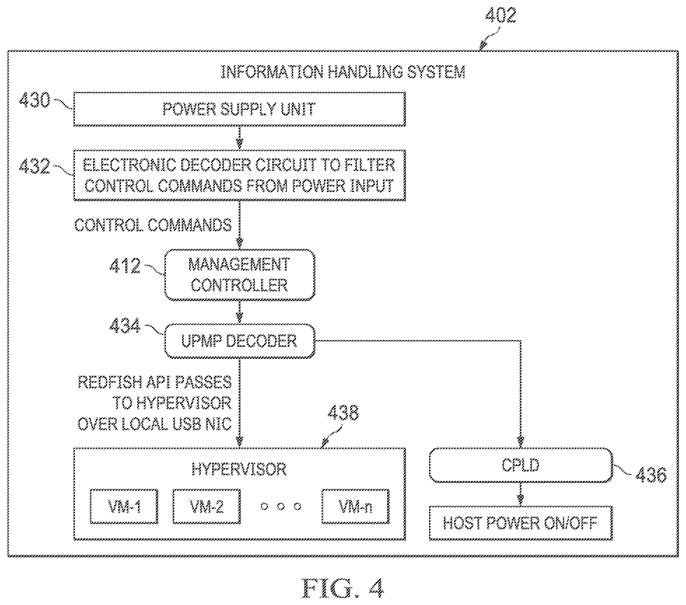

Turning now to FIG. 4, a block diagram of an example information handling system 402 is shown, in accordance with some embodiments of the present disclosure. Power supply unit 430 may receive power input from an AC or DC power distribution line of a datacenter. As discussed above, the power input may have control commands imposed thereon via power-line communication signals from a PLC hub (not shown in FIG. 4).

An electronic decoder circuit 432 (which may be disposed within power supply unit 430 or elsewhere) may filter the control commands out of the AC or DC power input and transmit them to management controller 412. In embodiments in which a UPMP protocol is used, a UPMP decoder 434 (which may be disposed within management controller 412 or elsewhere) may decode the control commands. In embodiments in which other protocols are used, a different corresponding type of decoder may be used.

If the decoded commands are for performing power management of information handling system 402 itself, then they may be passed to a complex programmable logic device (CPLD) 436 which is operable to carry out the commands by turning the host power on or off, and/or carrying out various other power management functionality.

If the decoded commands are for performing power management of a VM executing on hypervisor 438, then the commands may be passed to hypervisor 438 for execution. In some embodiments, such commands may be passed via an API such as a Redfish API over a local USB NIC.

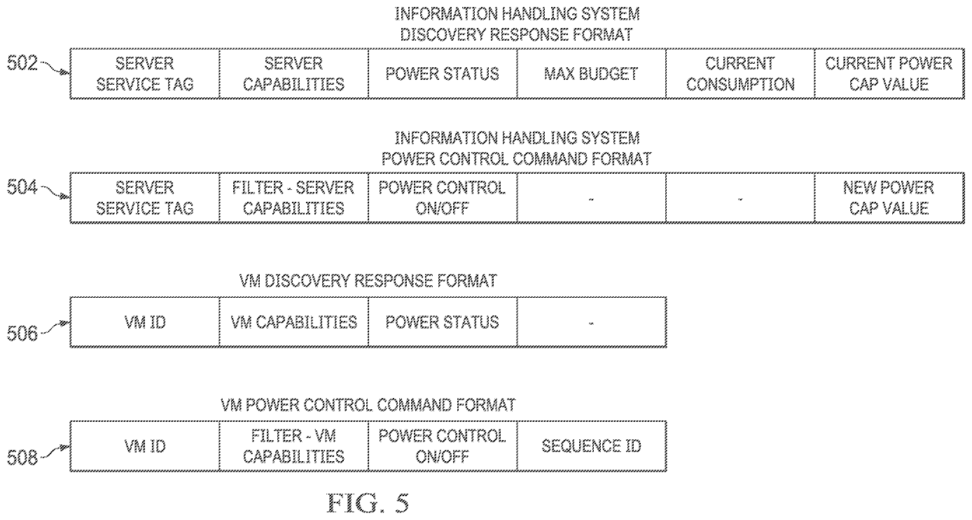

Turning now to FIG. 5, examples of command formats according to a UPMP protocol are shown. Command format 502 is an information handling system discovery response format; command format 504 is an information handling system power control command format; command format 506 is a VM discovery response format; and command format 508 is a VM power control command format. As noted above, such a UPMP protocol may be unified with respect to heterogeneous types of information handling system, as well as with respect to VMs that may execute on such systems.

With reference to command formats 502 and 504, Server Capabilities may be implemented as a bit map representing information such as the model and generation of the information handling system. A Power Cap value may be a percentage of the Max Budget, an absolute value (e.g., in Watts), etc. The Service Tag is used to uniquely represent a particular information handling system.

With reference to command formats 506 and 508, VM Capabilities may be implemented as a bit map representing the type of the VM, the criticality of the VM, etc. The VM ID may be used to uniquely represent a particular VM. The Sequence ID may be used to establish a desired sequence of events (e.g., power ON the VMs in a certain sequence after powering on the host, etc.). In some embodiments, the Sequence ID may specify the exact ordering that is desired; in other embodiments, the Sequence ID may be used to specify the relative importance of different VMs (e.g., critical, important, unimportant, etc.).

Accordingly, embodiments of this disclosure may be used to implement various solutions. For example, a power control solution may operate as follows in one embodiment.

The PLC hub may interpret the requests coming from user consoles (e.g., through Ethernet) or mobile applications (through a mobile network) and send out the corresponding UPMP commands to the destination on the appropriate power distribution line. At the information handling system receiving such commands, an electronic decoder circuit may filter the UPMP commands and transmit them to a management controller. The management controller may decode the UPMP command requests and control a CPLD to power ON/OFF the information handling system based on a host power control request. After powering ON the host, the management controller may map a Redfish request to the hypervisor for power control of VMs in the sequence designated by the Sequence ID. The PLC hub thus may manage servers and VMs even in the absence of a management network.

As another example, a power capping solution may operate as follows in one embodiment.

An external power management console (e.g., through Ethernet) or a mobile application (through a mobile network) may accumulate information regarding the power budget and cumulative current consumption of the information handling systems. Based on the active number of VMs, the power management console may prioritize particular information handling systems and run a power capping algorithm to decide on the new power cap values for the low priority information handling systems. The power management console may send the power cap UPMP request to the PLC hub, which in turn may convert it to one or more UPMP requests and send it to the destination system via the appropriate power distribution line. At the information handling system receiving such commands, an electronic decoder circuit may filter the UPMP commands and transmit them to a management controller. The management controller may decode the UPMP requests and interact with a node manager to apply the new power cap value.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
a host system; and
a management controller configured to provide out-of-band management of the information handling system;
wherein the information handling system is configured to receive power management instructions via a power input of the information handling system according to a power-line communication protocol; and
wherein the management controller is configured to execute the power management instructions, wherein executing the power management instructions includes performing at least one operation selected from the group consisting of: powering on the host system, powering off the host system, powering on a virtual machine, and powering off a virtual machine.

2. The information handling system of claim 1, further comprising decoder circuitry configured to filter the power management instructions from an AC power signal associated with the power input.

3. The information handling system of claim 2, wherein the decoder circuitry is disposed within a power supply unit of the information handling system.

4. The information handling system of claim 1, wherein the power management instructions comprise a unified power management protocol (UPMP).

5. The information handling system of claim 4, wherein the UPMP is configured to perform heterogeneous power management tasks with regard to information handling systems from multiple vendors and with regard to virtual machines.

6. The information handling system of claim 1, wherein the power management instructions include instructions for managing the host system, and wherein the information handling system further includes a complex programmable logic device (CPLD) configured to execute the instructions.

7. The information handling system of claim 1, wherein the power management instructions include instructions for managing virtual machines via a hypervisor of the information handling system, and wherein the management controller is configured to transmit the instructions to the hypervisor.

8. A method comprising:
in an information handling system comprising a host system and a management controller configured to provide out-of-band management of the information handling system:
receiving power management instructions via a power input of the information handling system according to a power-line communication protocol; and
the management controller executing the power management instructions, wherein executing the power management instructions includes performing at least one operation selected from the group consisting of: powering on the host system, powering off the host system, powering on a virtual machine, and powering off a virtual machine.

9. The method of claim 8, wherein the power management instructions include power capping instructions.

10. The method of claim 8, wherein the power management instructions include instructions for querying power information from the information handling system.

11. An apparatus comprising:
a processor;
a communications module configured to receive power management instructions from a user; and
a power-line communication module for communicating with at least one information handling system via a power distribution line;
wherein the apparatus is configured to transmit the power management instructions to the at least one information handling system via the power distribution line according to a power-line communication protocol; and
wherein a management controller of the information handling system is configured to execute the power management instructions, wherein executing the power management instructions includes performing at least one operation selected from the group consisting of: powering on a host system of the information handling system, powering off the host system, powering on a virtual machine, and powering off a virtual machine.

12. The apparatus of claim 11, wherein the communications module is an Ethernet module.

13. The apparatus of claim 11, wherein the communications module is a wireless networking module.

14. The apparatus of claim 13, wherein the wireless networking module is a mobile network module.

15. The apparatus of claim 11, wherein the power management instructions comprise a unified power management protocol (UPMP).

16. The apparatus of claim 15, wherein the UPMP is configured to perform heterogeneous power management tasks with regard to information handling systems from multiple vendors and with regard to virtual machines.

17. The apparatus of claim 11, wherein the power management instructions include power capping instructions.

18. The apparatus of claim 11, wherein the power management instructions include instructions for querying power information from the information handling system.

19. The apparatus of claim 11, wherein the power management instructions include instructions for managing a particular information handling resource of the at least one information handling system.

20. The apparatus of claim 19, wherein the particular information handling resource is a graphics processing unit (GPU).
